(19) United States
(12) Patent Application Publication
(10) Pub. No.: US 2008/0139321 A1
(43) Pub. Date: Jun. 12, 2008

(54) SPLICE SLEEVE MAGNET ASSEMBLY AND METHOD THEREOF

(75) Inventors: Ted Kegeris, Fairland, IN (US); David S. Jablonsky, Manchester, CT (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: JVI Magnetics, Inc., Fountaintown, IN (US)

(21) Appl. No.: 11/876,151

(22) Filed: Oct. 22, 2007

Related U.S. Application Data
(60) Provisional application No. 60/862,368, filed on Oct. 20, 2006.

(51) Int. Cl. F16D 27/14

(52) U.S. Cl. 464/29

(57) ABSTRACT

A splice sleeve magnet assembly including a mounting plate having a front surface and a back surface with an aperture therethrough, a circular plunger having a centrally-located aperture, a device connector having a first end and a second end to couple the mounting plate with the circular plunger, and at least one magnet located on the mounting plate front surface so that the splice sleeve magnet may be inserted into a construction element and the device connector tightened to securely lock the splice sleeve magnet within the construction element.

### CROSS-REFERENCE TO RELATED APPLICATIONS

This application claims priority of U.S. Provisional Patent Application No. 60/862,368, filed on Oct. 20, 2006, in the United States Patent & Trademark Office, the disclosure of which is incorporated herein by reference in its entirety.

### BACKGROUND OF THE INVENTION

1. Field of the Invention

The present general inventive concept relates to a splice sleeve magnet assembly, and more particularly, to a magnetic mounting plate coupled with a rubber plunger and fitted to a splice sleeve.

2. Description of the Related Art

Convention apparatuses utilize a splice sleeve having an attachment system requiring the drilling of holes and exact placement of the splice sleeve to align with the holes. A precast plant will position the convention system on a steel side rail and attach into place.

The attachment method of convention apparatuses is a time consuming, difficult operation. A user is required to constantly bend and position bolts thru the pre-drilled holes. A plunger is attached to the inside of the splice sleeve and a bolt is pushed thru the pre-drilled hole in the side form and screwed onto a back support plate. Concrete is then poured into the steel mold or form and envelopes the splice sleeve. After the concrete has cured, the bolts are removed and the final slab is stripped from the form. The convention apparatus is then removed from the splice sleeve.

Aside from being time consuming, conventional systems are further deficient because drilling holes in the side form is an expensive operation, reduces the life of the form, and decreases versatility with respect to locating the splice sleeve.

### SUMMARY OF THE INVENTION

A principal object of the present general inventive concept is to provide a spliced sleeve magnet apparatus that is easy to assemble, easy to use, and affords repeated use without drilling holes.

Another object of the present general inventive concept is to provide a spliced sleeve magnet apparatus having a mounting plate with at least magnet embedded in the mounting plate and a plunger coupled together.

Another object of the present general inventive concept is to provide a

The foregoing and other objects are intended to be illustrative of the present general inventive concept and are not meant in a limiting sense. Many possible embodiments of the present general inventive concept may be made and will be readily evident upon a study of the following specification and accompanying drawings comprising a part thereof. Various features and subcombinations of present general inventive concept may be employed without reference to other features and subcombinations. Other objects and advantages of this present general inventive concept will become apparent from the following description taken in connection with the accompanying drawings, wherein is set forth by way of illustration and example, an embodiment of this present general inventive concept and various features thereof.

### BRIEF DESCRIPTION OF THE DRAWINGS

A preferred embodiment of the present general inventive concept, illustrative of the best mode in which the applicant has contemplated applying the principles, is set forth in the following description and is illustrated in the drawings.

FIG. 1 illustrates a splice sleeve magnet illustrating an exemplary embodiment of the present general inventive concept having a nut, a rubber plunger, a washer, a mounting plate, another washer, and a bolt in order of assembly according to the exemplary embodiment of the present general inventive concept.

FIG. 2 illustrates the splice sleeve magnet of FIG. 1 having the assembly of the nut, the rubber plunger, the two washers and the bolt.

FIG. 3 illustrates the splice sleeve magnet of FIG. 1 and a sleeve before insertion in the sleeve.

FIG. 4 illustrates the splice sleeve magnet of FIG. 1 and the sleeve with the splice sleeve magnet coupled to the sleeve.

FIG. 5 illustrates the splice sleeve magnet of FIG. 1 and the sleeve with the splice sleeve magnet coupled to the sleeve.

FIG. 6 illustrates the splice sleeve magnet of FIG. 1 and the sleeve with the splice sleeve magnet coupled to the sleeve.

FIG. 7 illustrates the splice sleeve magnet of FIG. 1 and the sleeve attached to a steel structure with a person standing on the sleeve to illustrate the strength of the splice sleeve magnet.

FIG. 8 illustrates the splice sleeve magnet of FIG. 1 and the sleeve attached to a steel structure with a person standing on the sleeve to illustrate the strength of the splice sleeve magnet.

FIG. 9 illustrates the splice sleeve magnet of FIG. 1 fully assembled.

FIG. 10 illustrates the splice sleeve magnet of FIG. 1 illustrating a top view, a bottom view, and a side view of the splice sleeve magnet.

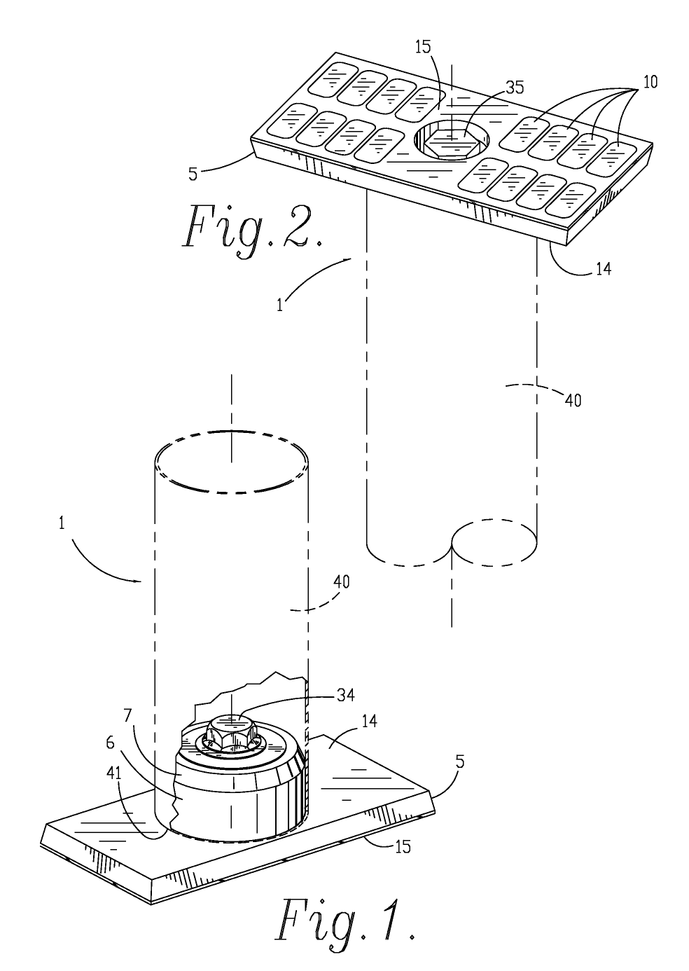

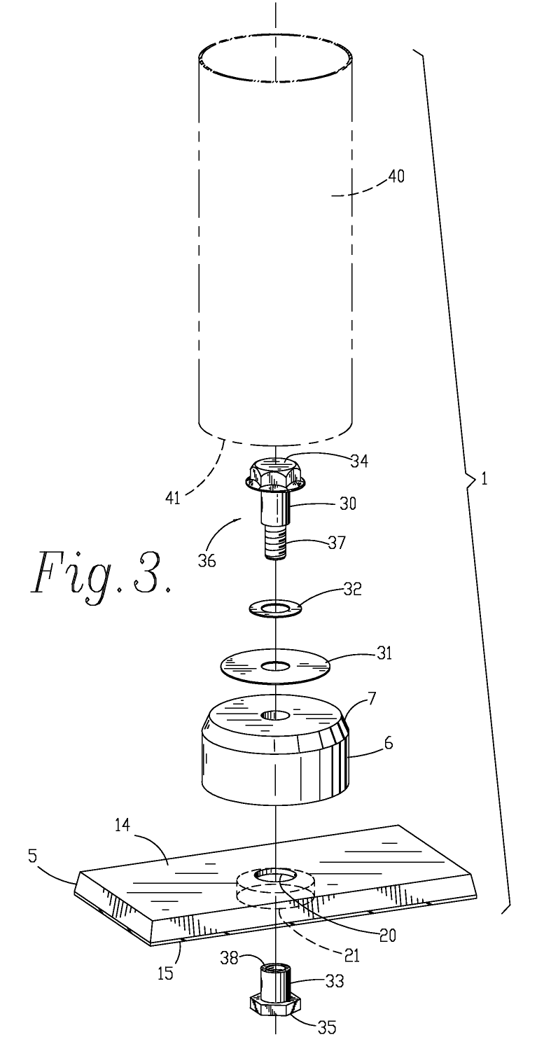

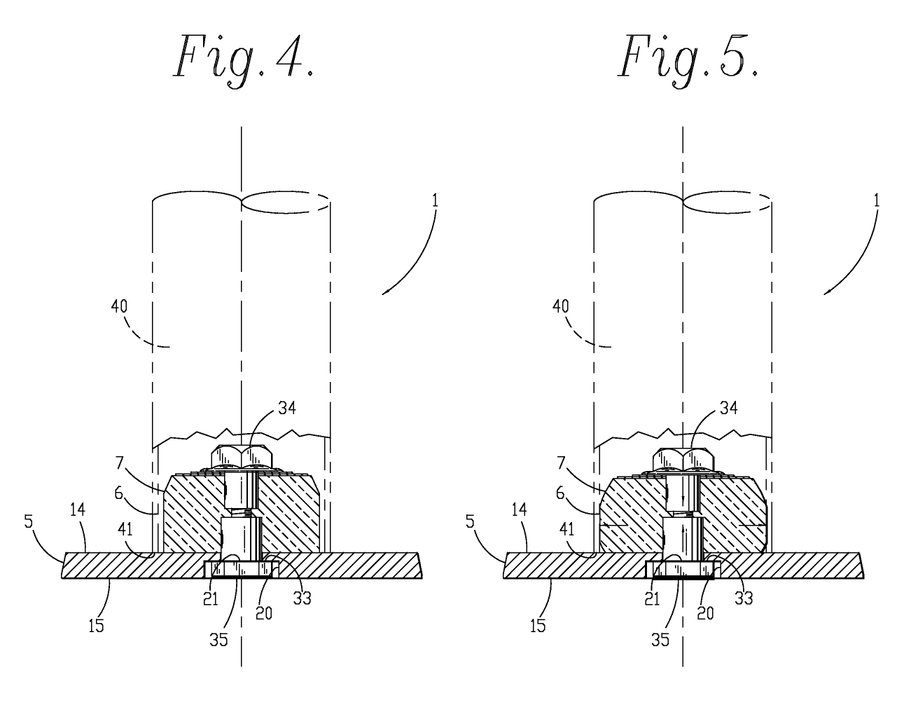

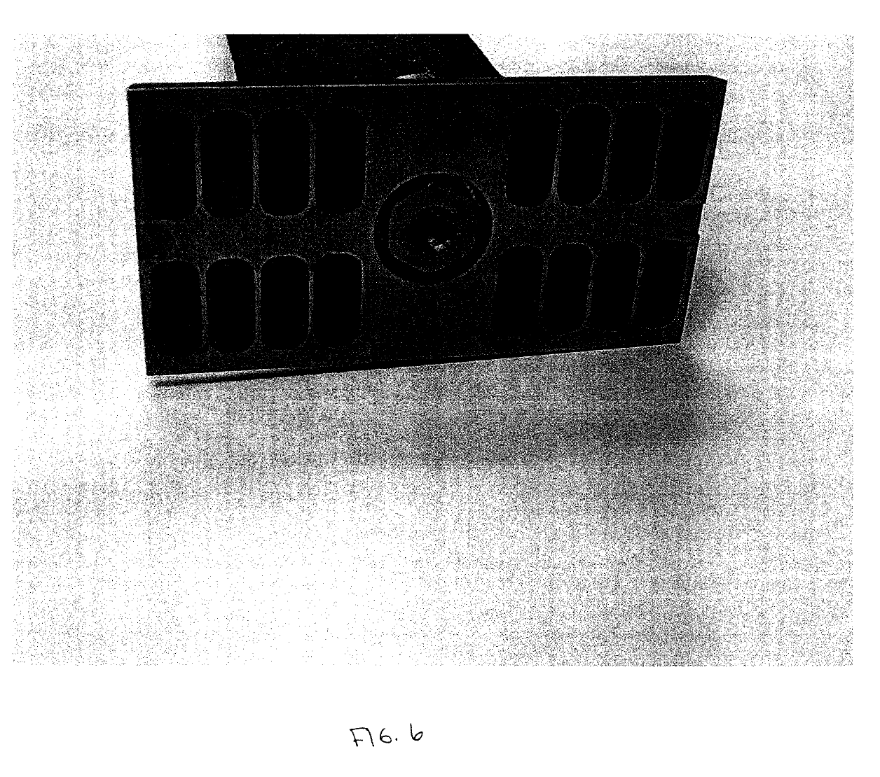

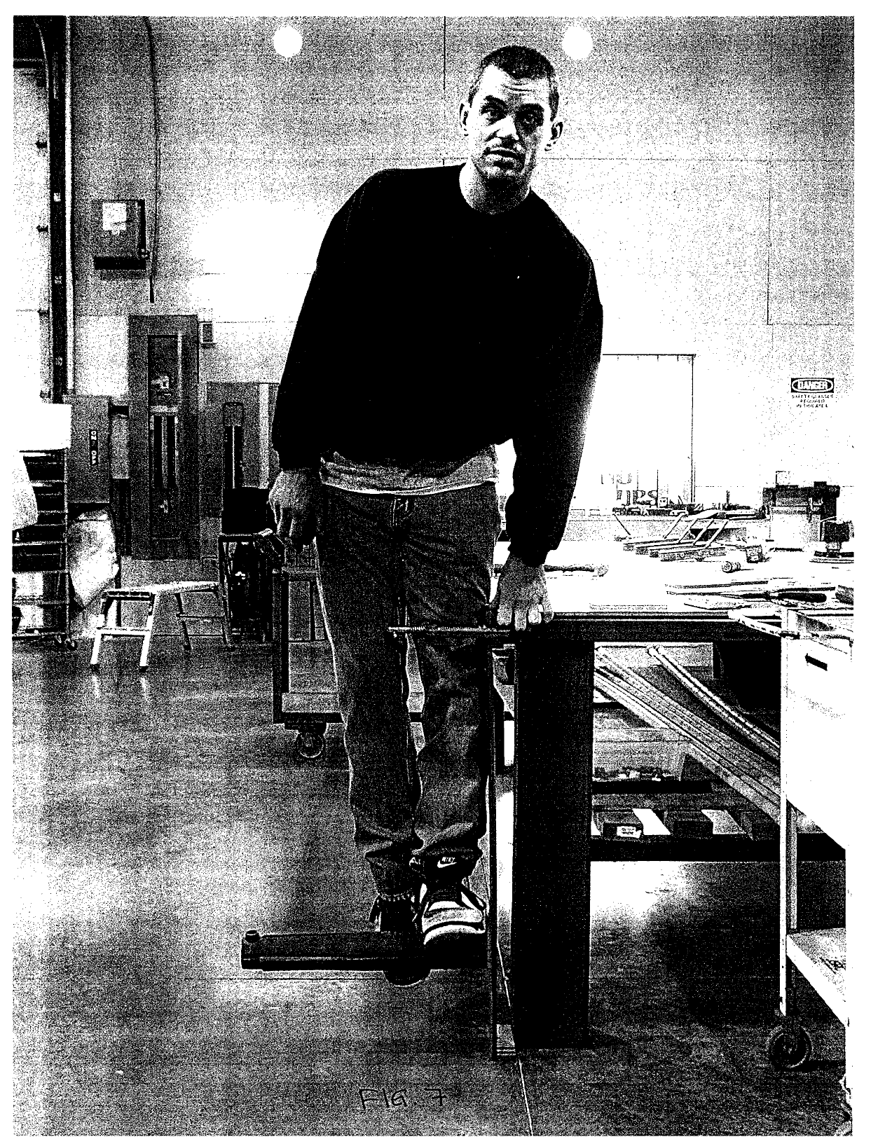

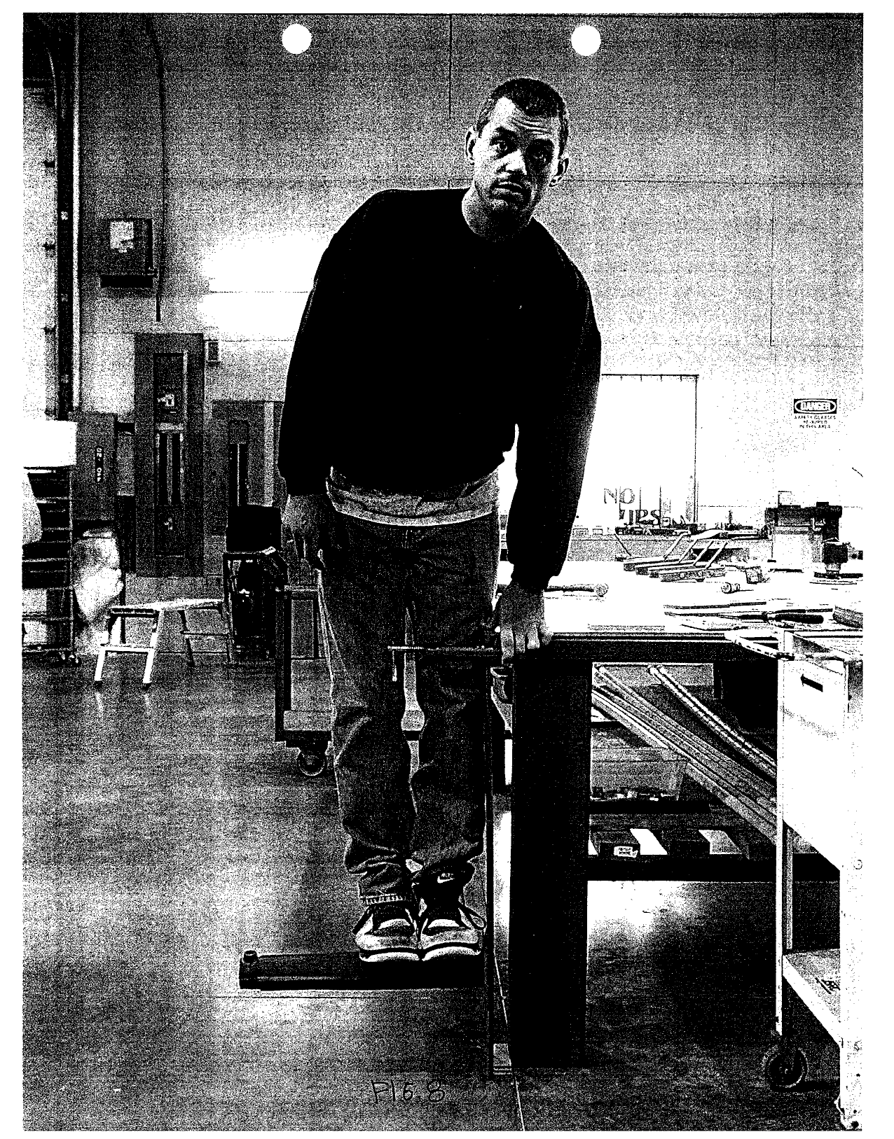

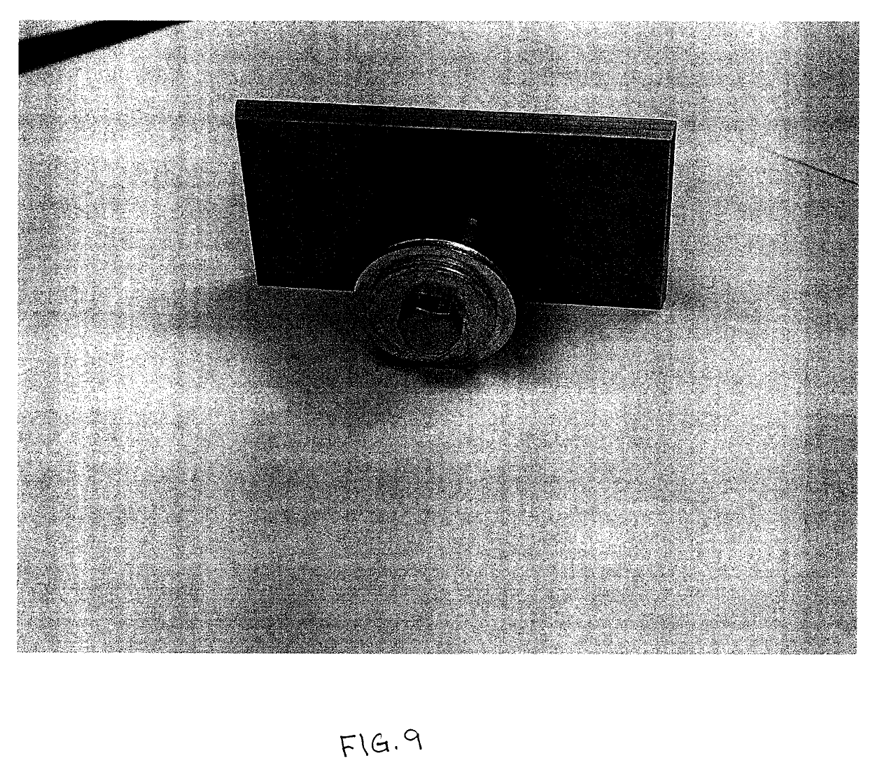

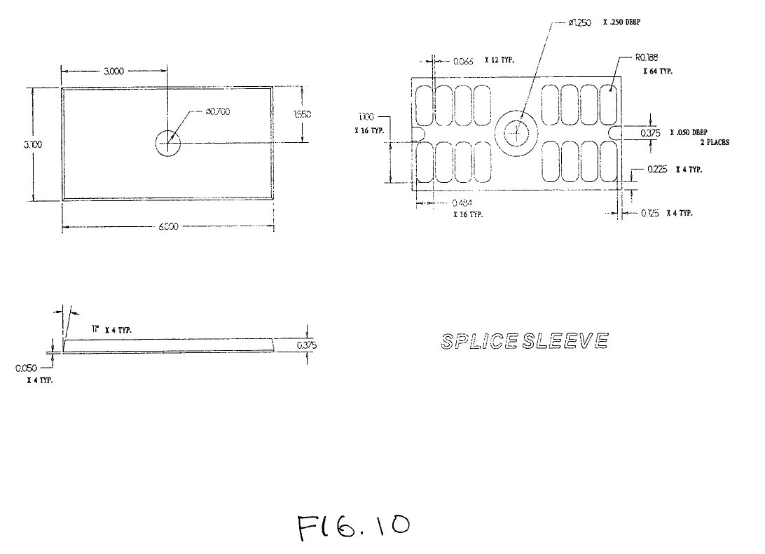

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept be referring to the figures.

FIG. 1 illustrates an exemplary embodiment of a spliced sleeve magnet assembly 1 having a mounting plate 5 and an elongated circular plunger 6 having a tapered end 7. The mounting plate 5 is made of steel or other like material and has a least one magnet 10 embedded within or attached to a front side 15 of the mounting plate 5. The mounting plate 5 has a back side 14 that acts to direct magnetism of the magnet 10 toward the front side 15 and provides a buffer zone on the back side 14.

A hole 20 having a recess 21 is located in a center of the mounting plate 5 to permit a bolt 30 or other like fastening part to fit therethrough to connect with washers 31 and 32, and a nut 33, which collaborate to form a connector device 36 having a first end 34 on the bolt 30 and a second end 35 on the nut 33. The bolt 30 has an outer threaded surface 37 that corresponds to an inner threaded surface 38 of the nut 33. The outer and inner threaded surfaces have a length corresponding to a length of the plunger 6.

The connector device 36 couples the mounting plate 5 to other parts of the spliced sleeve magnet assembly 1 assembly discussed hereafter. The recess 21 accommodates the first end 34 of the connector device 36 so the first end 34 is flush with front side 15.

The plunger 6 is made of rubber or other like compressible, non-metallic material that is unaffected by the magnet 10. In the exemplary embodiment, the plunger 6 and the connector device 36 fit into the end of a sleeve 40 for use in the construction of buildings or other concrete structures.

The sleeve 40 is made of a cast-iron tube sized and shaped to permit rebar (not illustrated) to enter into an end of the sleeve 40 and be supported in a desired orientation thereby.

In use, a user assembles the spliced sleeve magnet assembly 1 using the connector device 36 to loosely couple the mounting plate 5, the washers 31 and 32, and the plunger 6 with the tapered end 7 facing away from the mounting plate 5. The spliced sleeve magnet assembly 1 is then inserted, tapered end 7 of the plunger 6 first, into a wide end of the sleeve 40 until the sleeve 40 fully envelopes the plunger 6 and a sleeve edge 41 abuts the back side 14. The connector device 36 is then tightened, which forces the washers 31 and 32 into the plunger 6, thereby compressing the plunger 6 and expanding a circumference thereof. The increased circumference of the plunger 6 significantly increases the integrity of the seal formed between the plunger 6 and an inside surface of the sleeve 40. Upon tightening of the connector device 36, a water-tight seal is created to prevent concrete and/or other foreign substances from entering the splice sleeve.

The spliced sleeve magnet assembly 1 is placed on a steel form at a predetermined location per application requirements.

For drafted forms, a concrete pieces is stripped so that the spliced sleeve magnet assembly 1 will follow the concrete piece. A wrench may then be used to loosen and remove the nut 33 from back side 14 of the mounting plate 5. A special handle plate (not illustrated) can be used to engage the back side 14 of the mounting plate 5, at which point the handle plate may be pulled away from the concrete edge and mounting plate 5 will follow.

For pull away or rollback forms, a user may pull away or rollback a side form (not illustrated), strip the concrete piece so that the spliced sleeve magnet assembly 1 will follow the concrete piece. A wrench may be used to loosen and remove the nut 33 from back side 14 of the mounting plate 5. A special handle plate (not illustrated) can be used to engage the back side 14 of the mounting plate 5, at which point the handle plate may be pulled away from the concrete edge and mounting plate 5 will follow.

With regard to clearance, per Al Ericson and ACI code, the sleeve 40 should always have a 1″ minimum clearance between an outside of adjacent sleeves (not illustrated). The mounting plate 5 may be situated next to other mounting plates in a side-by-side fashion without affecting the required 1″ minimum clearance. The mounting plate 5 may be sized and shaped according to application. The mounting plate 5 may also be utilized with various sleeves that are now known in the industry, thereby increasing versatility and economic efficiency.

In other embodiments, the mounting plate 5 can be made taller to extend to a top of a form. The mounting plate 5 can be made with multiple attachment holes (not illustrated) based on the application's sleeve spacing requirements, which is advantageous because the mounting plate 5 may act as a template providing the user with tighter sleeve 40 location tolerances making for easier job site usage.

The splice sleeve magnet assembly 1 of the present general inventive concept can be used with construction elements other than the sleeve 40, as long as the other element has an open inside diameter.

Accordingly, the present general inventive concept does not require holes to be drilled, e.g., in the side of a form, thus eliminating an expensive operation, which increases form life and allows flexibility in placement of the sleeve 40. Other advantages of the present general inventive concept includes ease of process, e.g., the assembly takes less time and users are not required to constantly bend to position bolts thru holes, as required by conventional methods. Additionally, the water-tight seal that is formed by the plunger prevents concrete from entering the sleeve.

Having now described the features, discoveries and principles of the general inventive concept, the manner in which the general inventive concept is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the general inventive concept herein described, and all statements of the scope of the general inventive concept which, as a matter of language, might be said to fall therebetween.

What is claimed is:

1. A splice sleeve magnet assembly comprising:
a mounting plate having a front surface and a back surface with an aperture therethrough;
a circular plunger having a centrally-located aperture;
a device connector having a first end and a second end to couple the mounting plate with the circular plunger; and
at least one magnet located on the mounting plate front surface.

2. The splice sleeve magnet assembly according to claim 1 wherein the aperture is centrally located and has a recess on the mounting plate front surface.

3. The splice sleeve magnet assembly according to claim 2 wherein the recess accommodates the first end of the device connector so that the device connector is flush with the mounting plate front surface.

4. The splice sleeve magnet assembly according to claim 1 wherein the device connector has a first end having an outer threaded surface and a second end having an inner threaded surface.

5. The splice sleeve magnet assembly according to claim 4 wherein the outer and inner threaded surfaces permit a first splice sleeve magnet assembly configuration and a second splice sleeve magnet assembly configuration.

6. The splice sleeve magnet assembly according to claim 5 wherein the circular plunger is not compressed in the first configuration and the circular plunger is compressed in the second configuration.

7. The splice sleeve magnet assembly according to claim 1, wherein the mounting plate front surface defines a magnetic focal direction.

8. The splice sleeve magnet assembly according to claim 5, wherein the mounting plate front surface provides a buffer zone between the first and second magnetic portions and an outer surface of the outer plate layers.

9. The splice sleeve magnet assembly according to claim 1, further comprising:
a tapered portion on the circular plunger to facilitate insertion of the plunger.

10. A method of using a splice sleeve magnet assembly comprising:
providing a mounting plate having a front surface and a back surface with an aperture therethrough;
providing a circular plunger having a centrally-located aperture;
providing at least one magnet located on the mounting plate front surface;
coupling the mounting plate to the circular plunger with a device connector so that the device connector nests inside of the mounting plate and the circular plunger is not compressed; and
inserting the coupled mounting plate and circular plunger into a construction element; and
tightening the device connector so that the circular plunger is compressed.
